(19) United States
(12) Patent Application Publication
(10) Pub. No.: US 2007/0221828 A1
(43) Pub. Date: Sep. 27, 2007

(54) Optical input device, and methods of detecting input to an electronic device

(76) Inventors: Kuldeep Kumar Saxena, Singapore (SG); Wee Sin Tan, Singapore (SG); Soon Lee Tan, Singapore (SG)

Correspondence Address: Kathy Manke;Avago Technologies Limited, 4380 Ziegler Road, Fort Collins, CO, 80525, US

(21) Appl. No.: 11/389,372

(22) Filed: Mar. 23, 2006

(51) Int. Cl. G06M 7/00

(52) U.S. Cl. 250/221

(57) ABSTRACT

In one embodiment, an optical input device for providing input to an electronic device is disclosed. The optical input device includes a panel operable to transmit light from a first side to a second side, and a matrix of photodetectors. The first side of the panel is disposed for interaction with a pointer. The matrix of photodetectors is disposed on the second side of the panel, and detects the light transmitted from the first side to the second side of the panel. The photodetectors have overlapping fields of view with respect to the first side of the panel, and each of the photodetectors generates a value corresponding to an intensity of detected light.

### BACKGROUND

Electronic devices, such as computers, personal digital assistants (PDAs) and mobile telephones, may receive input in a variety of ways, including, by means of a computer input area. Computer input areas generally assume one of two forms: that of a touch pad comprising discrete sensors (e.g., a touch pad comprising an array of capacitive sensors), or that of a touch pad or other perimeter sensor comprising sets of intersecting detection paths (e.g., a touch pad comprising first and second intersecting sets of optical detection paths).

Optical infrared touch panels generally provide up to 100% transparency and require no touch force, which are properties that are especially desirable for liquid crystal display (LCD) applications. However, the arrangement of the emitters and detectors that provide the panel's intersecting sets of optical detection paths tends to increase the volume of space that is required to implement the touch panel. In general, any increase in the height, width or length of a touch panel limits the number of applications in which it can be used, or makes a handheld device larger than desired.

### SUMMARY OF THE INVENTION

In one embodiment, an optical input device for providing input to an electronic device comprises a panel operable to transmit light from a first side to a second side, with the first side of the panel being disposed for interaction with a pointer. The optical input device also comprises a matrix of photodetectors disposed on the second side of the panel, to detect the light transmitted from the first side to the second side of the panel. The photodetectors have overlapping fields of view with respect to the first side of the panel, and each of the photodetectors generates a value corresponding to an intensity of detected light.

In another embodiment, a method of detecting input to an electronic device comprises, in response to positioning of a pointer with respect to a first side of a transmissive panel, detecting, via a matrix of photodetectors that are i) disposed on a second side of the transmissive panel, and ii) have overlapping fields of view with respect to the first side of the transmissive panel, a shadow in the field of view of at least one of the photodetectors. The shadow is created by the pointer blocking ambient light from reaching the at least one of the photodetectors. A position of the pointer with respect to the transmissive panel is then determined based on a change in a value generated by the at least one of the photodetectors (with the value(s) corresponding to intensities of detected light).

In yet another embodiment, a method of detecting input to an electronic device comprises illuminating a first side of a transmissive panel with a light. Then, in response to positioning of a pointer with respect to the first side of the transmissive panel, and via a matrix of photodetectors that are i) disposed on a second side of the transmissive panel, and ii) have overlapping fields of view with respect to the first side of the transmissive panel, a reflection of the light into, or absorption of the light from, the field of view of at least one of the photodetectors is detected. The reflection or absorption of the light is caused by interaction of the pointer with the panel. A position of the pointer with respect to the transmissive panel is then determined based on a change in a value generated by the at least one of the photodetectors (with the value(s) corresponding to intensities of detected light).

Other embodiments are also disclosed.

### BRIEF DESCRIPTION OF THE DRAWINGS

Illustrative embodiments of the invention are illustrated in the drawings, in which:

FIG. 1 is a cross-sectional view of an exemplary portion of an optical input device having a pair of photodetectors disposed below a transmissive panel;

FIG. 2 is a plan view of an exemplary optical input device having a matrix of photodetectors positioned below an LCD panel;

FIG. 3 is a cross-sectional view of an exemplary portion of the optical input device shown in FIG. 2;

FIG. 4 illustrates exemplary movement of a pointer across the field of view of one of the photodetectors shown in FIGS. 1-3;

FIG. 5 is a an exemplary plot of the strength of 1) a signal generated by the photodetector shown in FIG. 4, versus 2) the position of a pointer on the LCD panel with respect to the photodetector;

FIG. 6 is an exemplary plot of the strength of the signal generated by the photodetector shown in FIG. 4, as a pointer is moved across the entire field of view of the photodetector;

FIG. 7 illustrates placement of a pointer at discrete positions with respect to a pair of photodetectors disposed below a transmissive panel (with the signals generated by each photodetector in response to the various pointer positions being set forth in Table 1 of the following Detailed Description);

FIG. 8 is a side view of an exemplary portion of an optical input device in which photodetectors are disposed below a transmissive panel and LEDs are disposed at the sides of the transmissive panel;

FIG. 9 is a plan view of the optical input device shown in FIG. 8;

FIG. 10 is a side view of an exemplary portion of an optical input device in which photodetectors are disposed below an LCD panel and LEDs are disposed at the sides of the LCD panel; and

FIG. 11 is a plan view of the optical input device shown in FIG. 10.

### DETAILED DESCRIPTION

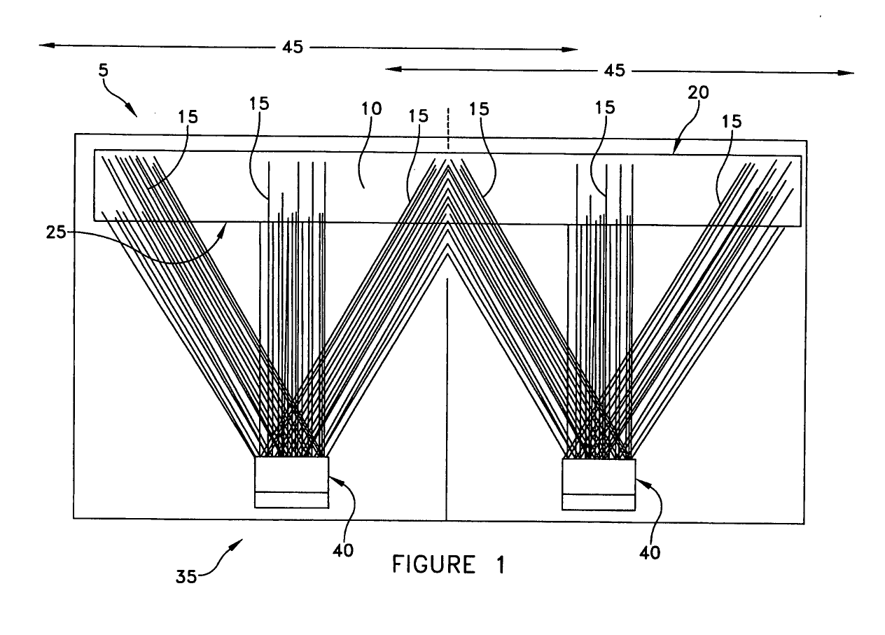

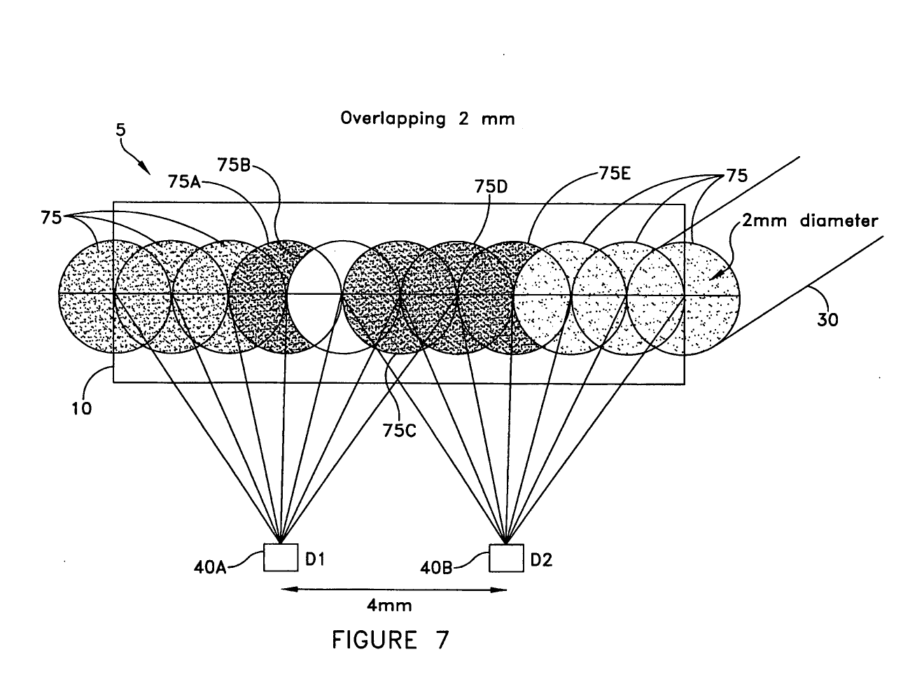

Novel optical input devices for providing input to an electronic device include photodetectors disposed below a transmissive panel. In one embodiment, and as best shown in FIG. 1, an optical input device 5 includes a panel 10 operable to transmit light 15 from a first side 20 to a second side 25. First side 20 is disposed for interaction with a pointer 30 (see FIG. 7), such as a finger or stylus. A matrix 35 of photodetectors 40 (e.g., 40A, 40B in FIG. 7) may be disposed on second side 25 of panel 10. Generally, each of photodetectors 40 has a field of view 45 to detect light 15, with the fields of view 45 of adjacent photodetectors 40 overlapping one another (see FIG. 1). Each of photodetectors 40 may generate a value corresponding to an intensity of detected light 15. An optional control system (not shown), coupled to the photodetectors 40, may be provided for determining a position of pointer 30 with respect to panel 10 based on the values generated by the photodetectors 40 (see FIGS. 1 & 7).

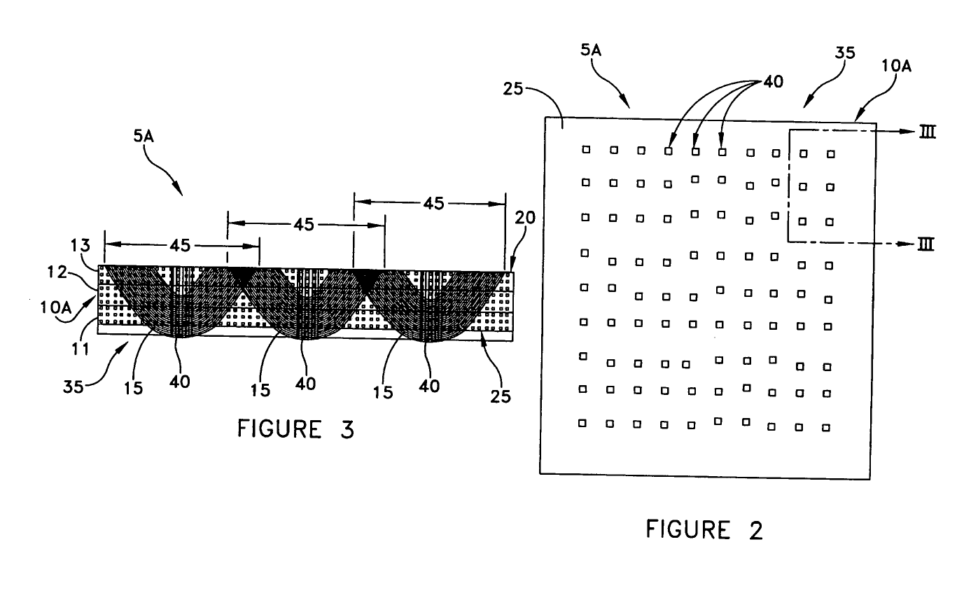

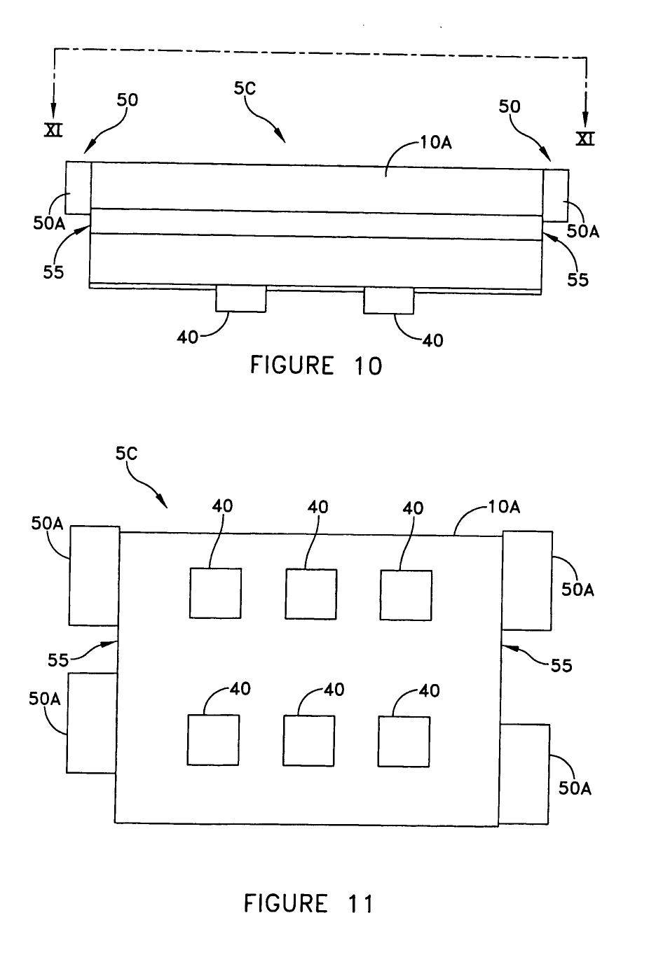

Panel 10 may include, but is not limited to, a plastic sheet, a glass plate, a display device of a PDA, a display device of a mobile telephone, or an LCD panel 10A (see FIGS. 2, 3, 10 & 11).

In one embodiment, light 15 detected by matrix 35 of photodetectors 40 may be ambient light. This ambient light may be received from the environment surrounding optical input device 5. Some examples of ambient light include sunlight, fluorescent light, and incandescent light. In one embodiment, photodetectors 40 may include visible light photodiodes, and pointer 30 may create a shadow on the field of view 45 of at least one of the photodetectors 40. A control system may then be used to determine the position of pointer 30 with respect to panel 10 based on a change in the value(s) generated by at least one of the photodetectors 40.

FIGS. 2 and 3 illustrate an optical input device 5A comprising a matrix 35 of photodetectors 40 positioned below an LCD panel 10A. FIG. 2 illustrates a plan view of the device 5A, and FIG. 3 illustrates a cross-section of a portion of the device 5A. By way of example, the LCD panel 10A is shown to be a color LCD panel comprising layers 11, 12 and 13 of red, green and blue colored liquid crystal material. The photodetectors 40 may be mounted, for example, on a printed circuit board or other substrate that is positioned below the LCD panel 10A. The spacing of the photodetectors 40 may be determined based on the fields of view 45 of the photodetectors 40, and the depth of the LCD panel 10A. As shown in FIG. 3, photodetectors 40 may be arranged a distance apart from one another so as to cause their fields of view 45 to overlap. While non-overlapping configurations are possible, these configurations can result in “dead” areas, where the position of a pointer 30 cannot be detected. The photodetectors 40 may also be arranged in a uniform grid, or in a staggered or patterned arrangement, as shown in FIG. 2.

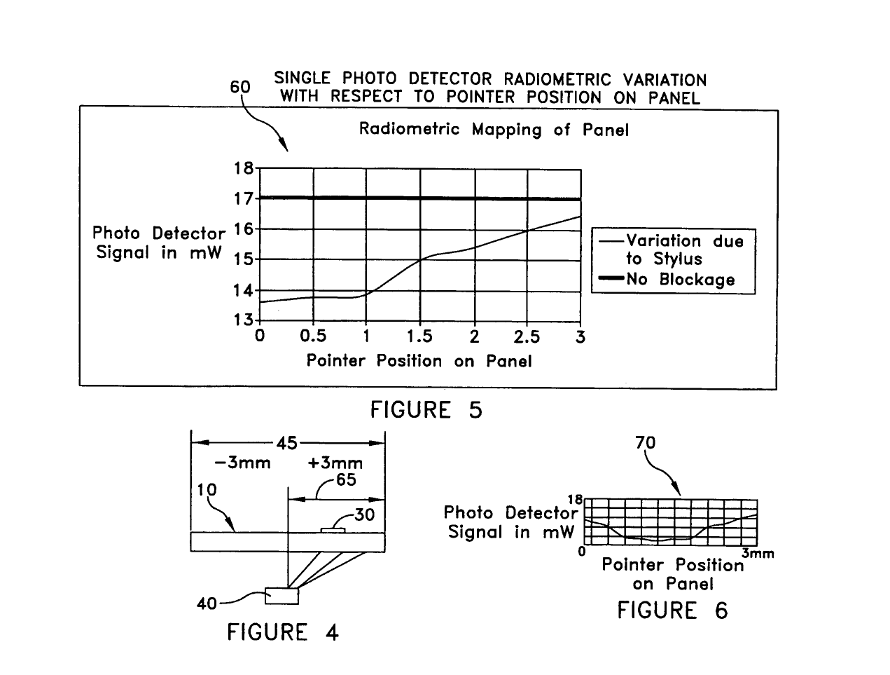

FIG. 4 illustrates placement of pointer 30 with respect to one of the photodetectors 40. By way of example, the photodetector 40 shown in FIG. 4 is shown to have a field of view 45 with a radius 65 of 3 millimeters (3 mm) with respect to panel 10.

FIG. 5 illustrates an exemplary, simulated plot 60 of 1) the strength of a signal generated by the photodetector 40 shown in FIG. 4 (in milliwatts (mW)) versus 2) the position of pointer 30 on LCD panel 10 with respect to photodetector 40 (in millimeters). In one embodiment, the signal generated by the photodetector 40 is a current, and the values acquired from photodetector 40 by a control system are currents.

As shown in the simulated plot 60 (FIG. 5), the detector signal may be 17 mW when there is no blockage of light 15 by pointer 30, and the detector signal may vary from about 13.6 mW to about 16.6 mW when pointer 30 casts varying amounts of shadow on photodetector 40. As one can see, the strength of the detector signal may increase as pointer 30 moves more to the periphery of the photodetector's field of view 45. Alternately, the photodetectors 40 could be designed such that their signals decrease as pointer 30 moves to the peripheries of their fields of view 45.

Whereas FIG. 5 illustrates a detailed simulation of the strength of the photodetector's signal over one-half of the photodetector's filed of view, FIG. 6 illustrates a less detailed simulation of the strength of the photodetector's signal over its entire field of view 45. When a plurality of the photodetectors 40 is arranged to form a matrix 35 of photodetectors, a control system may determine the location of a pointer 30 by monitoring differences (i.e., changes) in the signal values of two or more of the photodetectors 40.

FIG. 7 illustrates placement of pointer 30 at discrete positions with respect to a pair of photodetectors 40A, 40B disposed below transmissive panel 10. Exemplary simulated signals generated by each photodetectors 40A and 40B in response to the various pointer positions 75, including positions 75A, 75B, 75C, 75D and 75E, are set forth in TABLE 1.

TABLE 1

| | SIGNAL AT | SIGNAL AT |
|---|---|---|
| POSITION | PHOTODETECTOR 40A | PHOTODETECTOR 40B |
| 75A | 13.6 mW | 17.0 mW |
| 75B | 13.9 mW | 16.6 mW |
| 75C | 15.5 mW | 15.5 mW |
| 75D | 16.6 mW | 13.9 mW |
| 75E | 17.0 mW | 13.6 mW |

The optical input devices shown in FIGS. 1-3, in particular, may be advantageous in some situations in that light sources having a greater height than the panel 10 or 10A need not be mounted around the panel 10 or 10A, thereby giving the optical input device 5 or 5A a lower height than other optical input devices (such as optical input devices that rely on intersecting paths of light) and enabling the optical input device 5 or 5A to be used in a wider range of applications (such as in small, mobile electronic devices).

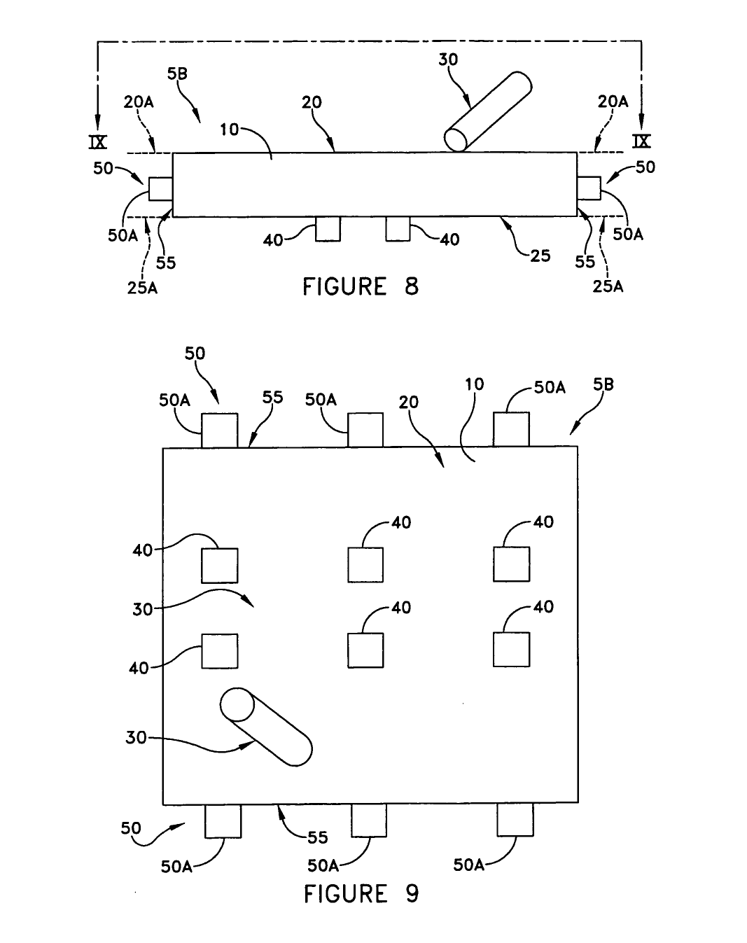

In another embodiment, and as best shown in FIGS. 8-11, an optical input device 5B or 5C may be provided with one or more light sources 50 to illuminate a first side 20 of the panel 10 or LCD panel 10A. Each light source 50 provides some or all of the light 15 detected by matrix 35 of photodetectors 40 (see also, FIG. 1). Pointer 30 may then reflect/absorb light 15 emitted from light source 50 into/from the field of view of at least one of the photodetectors 40. A control system may then determine the position of pointer 30 with respect to panel 10 (or LCD panel 10A) based on changes in the light in the fields of view of the photodetectors 40, as indicated by the values (e.g., currents) generated by the photodetectors 40.

In one embodiment, the light sources 50 used to illuminate panel 10 or 10A may be light emitting diodes (LEDs 50A), such as visible or infrared LEDs.

Looking at FIGS. 8-11, panel 10 or LCD panel 10A has a perimeter 55, and light sources 50 are disposed adjacent perimeter 55 of panel 10. In one embodiment, pointer 30 may reflect or absorb the light that is emitted from the light source(s) 50 which are disposed adjacent perimeter 55, thereby causing a different amount of light to be reflected into the field of view of at least one of photodetectors 40. A control system (e.g., one comprising hardware or software) may then be used to determine the position of pointer 30 adjacent panel 10.

As best shown in FIG. 8, light source 50 may be mounted within the width of panel 10. For example, a first plane 20A may extend outwardly and in parallel to first side 20, and a second plane 25A may extend outwardly and in parallel to second side 25. Light source 50 may be disposed between first plane 20A and second plane 25A. In one embodiment, pointer 40 may reflect light 15 emitted from light source 50, which is mounted within the width of panel 10, into the field of view of at least one of photodetectors 40.

In accord with the above teachings, a first exemplary method of detecting input to an electronic device may comprise, in response to positioning of a pointer with respect to a first side of a transmissive panel, detecting, via a matrix of photodetectors that are i) disposed on a second side of the transmissive panel, and ii) have overlapping fields of view with respect to the first side of the transmissive panel, a shadow in the field of view of at least one of the photodetectors. The shadow is created by the pointer blocking ambient light from reaching one or more of the photodetectors. A position of the pointer with respect to the transmissive panel may then be determined based on a change in a value generated by the at least one of the photodetectors, the value(s) corresponding to intensities of detected light.

A second exemplary method of detecting input to an electronic device may comprise illuminating a first side of a transmissive panel with a light. Then, in response to positioning of a pointer with respect to the first side of the transmissive panel, and via a matrix of photodetectors that are i) disposed on a second side of the transmissive panel, and ii) have overlapping fields of view with respect to the first side of the transmissive panel, a reflection of the light into, or absorption of the light from, the field of view of at least one of the photodetectors may be detected. The reflection or absorption of the light is caused by interaction of the pointer with the panel. A position of the pointer with respect to the transmissive panel based may be determined based on a change in a value generated by the at least one of the photodetectors, the value(s) corresponding to intensities of detected light.

What is claimed is:

1. An optical input device for providing input to an electronic device, the optical input device comprising:
a panel operable to transmit light from a first side to a second side, the first side being disposed for interaction with a pointer; and
a matrix of photodetectors disposed on the second side of the panel to detect the light transmitted from the first side to the second side of the panel, the photodetectors having overlapping fields of view with respect to the first side of the panel, and each of the photodetectors generating a value corresponding to an intensity of detected light.

2. The optical input device of claim 1, further comprising a control system to determine a position of the pointer with respect to the panel based on the values generated by the photodetectors.

3. The optical input device of claim 1, wherein the panel comprises one selected from the group consisting of: a plastic sheet, a glass plate, a display device of a PDA, a display device of a mobile telephone, and an LCD panel.

4. The optical input device of claim 1, wherein the photodetectors detect ambient light.

5. The optical input device of claim 4, further comprising a control system to determine a position of the pointer with respect to the panel based on the values generated by the photodetectors; wherein interaction of the pointer with the panel creates a shadow in the field of view of at least one of the photodetectors; and wherein the control system determines the position of the pointer with respect to the panel based on a change in the value(s) generated by the at least one of the photodetectors.

6. The optical input device of claim 1, further comprising a light source to illuminate the first side of the panel.

7. The optical input device of claim 6, further comprising a control system to determine a position of the pointer with respect to the panel based on the values generated by the photodetectors; wherein interaction of the pointer with the panel causes light emitted from the light source to be reflected or absorbed so as to vary the light in the field of view of at least one of the photodetectors; and wherein the control system determines the position of the pointer with respect to the panel based on a change in the value(s) generated by the at least one of the photodetectors.

8. The optical input device of claim 6, wherein the panel has a perimeter, and wherein the light source is disposed adjacent the perimeter of the panel.

9. The optical input device of claim 8, further comprising a control system to determine a position of the pointer with respect to the panel based on the values generated by the photodetectors; wherein interaction of the pointer with the panel causes light emitted from the light source to be reflected or absorbed so as to vary the light in the fields of view of at least one of the photodetectors; and wherein the control system determines the position of the pointer with respect to the panel based on a change in the value(s) generated by the at least one of the photodetectors.

10. The optical input device of claim 8, wherein the first side of the panel defines a first plane; wherein the second side of the panel defines a second plane, extending parallel to the first plane; and wherein the light source is disposed between the first plane and the second plane.

11. The optical input device of claim 6, wherein the light source comprises at least one LED.

12. The optical input device of claim 1, wherein the photodetectors comprise photodiodes.

13. The optical input device of claim 1, wherein the values generated by the photodetectors comprise currents.

14. A method of detecting input to an electronic device, comprising:
in response to positioning of a pointer with respect to a first side of a transmissive panel, detecting, via a matrix of photodetectors that are i) disposed on a second side of the transmissive panel, and ii) have overlapping fields of view with respect to the first side of the transmissive panel, a shadow in the field of view of at least one of the photodetectors, the shadow being created by the pointer blocking ambient light from reaching the at least one of the photodetectors; and
determining a position of the pointer with respect to the transmissive panel based on a change in a value generated by the at least one of the photodetectors, the value(s) corresponding to intensities of detected light.

15. A method of detecting input to an electronic device, comprising:
illuminating a first side of a transmissive panel with a light;
in response to positioning of a pointer with respect to the first side of the transmissive panel, detecting, via a matrix of photodetectors that are i) disposed on a second side of the transmissive panel, and ii) have overlapping fields of view with respect to the first side of the transmissive panel, a reflection of the light into, or absorption of the light from, the field of view of at least one of the photodetectors, the reflection or absorption of the light being caused by interaction of the pointer with the panel; and
determining a position of the pointer with respect to the transmissive panel based on a change in a value generated by the at least one of the photodetectors, the value(s) corresponding to intensities of detected light.

16. The method of claim 15, further comprising, illuminating the first side of the transmissive panel using a light source disposed adjacent a perimeter of the transmissive panel.

17. The method of claim 15, wherein the first side of the panel defines a first plane; wherein the second side of the panel defines a second plane, extending parallel to the first plane; and wherein the first side of the transmissive panel is illuminated via a light source disposed between the first plane and the second plane.

18. The method of claim 15, further comprising, illuminating the first side of the transmissive panel using at least one LED light source.
